(19) United States
(12) Patent Application Publication
(10) Pub. No.: US 2020/0143384 A1
(43) Pub. Date: May 7, 2020

(54) TERMS AND CONDITIONS SUMMARIZING

(71) Applicant: Comenity LLC, Columbus, OH (US)

(72) Inventors: Aimee KOONTZ, Upper Arlington, OH (US); Christian BILLMAN, Gahanna, OH (US)

(73) Assignee: Comenity LLC, Columbus, OH (US)

(21) Appl. No.: 16/577,820

(22) Filed: Sep. 20, 2019

Related U.S. Application Data
(60) Provisional application No. 62/755,227, filed on Nov. 2, 2018.

(51) Int. Cl. G06Q 30/00; G06N 20/00; G06F 16/9538

(52) U.S. Cl. CPC G06Q 30/01; G06F 16/9538; G06N 20/00

(57) ABSTRACT

A method of summarizing the terms and conditions of a customer agreement using the artificial intelligence of a computer system that receives a plurality of sets of terms and conditions for customer agreements. The artificial intelligence of the computer system also receives customer feedback on the plurality of sets of terms and conditions. The artificial intelligence trains to become a smart summarizer configured to summarize aspects of the plurality of sets of terms and conditions based on the customer feedback. The smart summarizer receives a new set of terms and conditions for a customer agreement. The smart summarizer creates a summary of the new set of terms and conditions. The smart summarizer outputs the summary in a human-readable format. The summary may be sent to a customer who is subject to the terms and conditions.

### CROSS-REFERENCE TO RELATED APPLICATIONS (PROVISIONAL)

This application claims priority to and benefit of co-pending U.S. Provisional Patent Application No. 62/755,227 filed on Nov. 2, 2018, entitled “TERMS AND CONDITIONS SUMMARIZING” by Aimee Koontz et al., and assigned to the assignee of the present application, the disclosure of which is hereby incorporated herein by reference in its entirety.

### BACKGROUND

An account such as a credit account, bank account, customer loyalty/reward account, or the like typically has a set of terms and conditions which govern the roles and responsibilities of the account issuer (bank, merchant, company, or the like) and of the account holding customer. The terms and conditions may define things such as, but not limited to: the billing cycle of an account; chargeable fees; the minimum payment required on the balance of the account; the payment due date for the account; the number of points awarded per dollar spent on the account; cancellation conditions for the account; responsibilities in the event of theft/misuse of the account; expiration of loyalty/reward points; and the interest rate charged on the account. An accountholder should be aware of and understand the terms and conditions applicable to their account because a failure to comprehend such terms and conditions can lead to misunderstandings and confusion. Because of this, issuers of accounts may be motivated, or even required by law, to advise account holding customers of some aspects of the terms and conditions and/or provide customers with access to the terms and conditions applicable to their account. Likewise, when terms and conditions change during the life of the account, account issuers may be similarly motivated, or required by law, to advise account holding customers and/or provide them with access to the applicable terms and conditions.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 illustrates a block diagram of a computer system which includes an artificial intelligence based smart summarizer, in accordance with various embodiments.

FIG. 2 illustrates a block diagram of the operation of the computer system which includes an artificial intelligence based smart summarizer, in accordance with various embodiments.

FIG. 3A is a diagram illustrating the creation of a summary and an approved summary from a set of terms and conditions, in accordance with an embodiment.

FIG. 3B is a diagram illustrating the creation of a summary and an approved summary from a set of terms and conditions, in accordance with an embodiment.

FIG. 4 depicts an example message to be sent to one or more customers, in accordance with various embodiments.

FIG. 5A illustrates a webpage 500A which permits a user of the webpage to request a summary of a set of terms and conditions, in accordance with various embodiments.

FIG. 5B illustrates a webpage 500B which is displaying a summary returned in response to a request for a summary of a set of terms and conditions, in accordance with various embodiments.

FIGS. 6A-6D depict a flow diagram of a method of summarizing terms and conditions of a customer agreement, in accordance with various embodiments.

FIG. 7 depicts a flow diagram of a method of providing summarized terms and conditions of a customer agreement, in accordance with various embodiments.

FIG. 8 is a block diagram of an example computer system with which or upon which various embodiments describe herein may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “receiving,” “training,” “summarizing,” “creating,” “outputting,” “revising,” “sending,” “generating,” “providing,” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

It should be appreciated that, to any extent it is described herein, the obtaining or accessing of user/account holding customer information conforms to applicable privacy laws (e.g., federal privacy laws, state privacy laws, etc.) and applicable fair credit reporting act laws. In one embodiment, prior to accessing such information, the user/account holding customer affirmatively “opts-in” to the services described herein. For example, during the use of an account issuer's mobile application, the user of the mobile application is prompted with a choice to affirmatively “opt-in” to various services. As a result, any information is obtained with prior permission. It should be appreciated that, depending on present or future credit account and/or bank account requirements, rules, and regulations, the account terms and conditions summaries and/or messaging described herein may be more or less formal than the examples provided for illustration and/or discussion.

Moreover, the embodiments described herein do not recite a mathematical algorithm; nor do they recite a fundamental economic or longstanding commercial practice. Instead, they address a number of business challenges including providing information to account holding customers regarding terms and conditions of customer agreements to which they are subject. Thus, the embodiments do not merely recite the performance of some business practice known from the pre-Internet or pre-computer world along with the requirement to perform it on the Internet and/or with a computer. Instead, the embodiments are necessarily rooted in computer technology in order to overcome problems specifically arising in the realm of information and notifications provided by account issuers (banks, merchants, companies, or the like) regarding a customer account (e.g., credit account, bank account, customer loyalty/reward account, or the like). For example, as will be discussed, the scale of what is described could not be accomplished absent the use of computers and artificial intelligence.

### Overview

People are constantly bombarded with information. Phone calls, text messages, mail, email, and other communication means are flooded with content which competes for the user's attention. Because of this, many people just skim content or do not read it at all if it seems like it will take considerable time or effort. An expression of the frustration caused by this information overload is often seen in text message responses or in comments to online forums when a person uses the response of “tl;dr” or “tldr” to indicate that something was “too long; didn't read.” Legal language, such as terms and conditions associated with an account, can often be extremely lengthy and hard to decipher and thus can easily fall into the tl;dr category. Accordingly, many account holding customers (often referred to as simply “customers” or “customer” herein) do not read or else do not extract important information from the terms and conditions of customer agreements which they may be subject to as account holders of credit accounts, bank accounts, customer loyalty/reward accounts, and the like.

Even though terms and conditions for an account may be lengthy and/or confusing, it is often beneficial to know what is in the terms and conditions, or at least be aware of the aspects which are important to a customer. There is a clear benefit for both the customer and the merchant/issuer of the account when a customer understands the terms and conditions which are associated with the account. For example, with a better understanding of an account's terms and conditions, a customer is less likely to be surprised or upset by an occurrence with the account (e.g., a fee, an interest charge, a payment due date, or the like). Similarly, if a customer has a better understanding of an account's terms and conditions, an issuer of an account (e.g., a merchant, bank, or other organization) may field fewer customer questions, receive fewer customer complaints, and/or incur lower customer turnover.

The technology for summarizing an account's terms and conditions is described herein. Such technology will increase a customer's understanding of the terms and conditions to which they are subject as an account holding customer. This technology advantageously improves the experience of both account holder customers and account issuers, by presenting aspects of the terms and conditions in a summarized fashion which is easier to understand and more likely to be read by a customer account holder. Much of what is described herein is automated using artificial intelligence implemented by a computer, as it would not be possible for one or more humans to perform the actions described herein at the scale described. That is, a human could not synthesize and train from all the information which is used to train the artificial intelligence. With respect to scale, the number of accounts involved, number and length of terms and conditions involved, and particularly the amount of customer feedback used for training and guiding the artificial intelligence, are beyond the capacity of one or more humans to synthesize and act upon, especially in any reasonable period to allow for the use and benefits described herein. Certainly, a person or persons could summarize one or more aspects of a set of terms and conditions for an account, but the person/persons could not do the same based on learning from the voluminous amount of customer feedback which is described herein as training data for an artificial intelligence.

Discussion begins with a description of a computer system which includes an artificial intelligence based smart summarizer, followed by a description of the operation of the smart summarizer. The smart summarizer is trained to summarize terms and conditions associated with an account. Examples are provided of summaries of terms and conditions as well as of a message to be sent to an account holding customer. Various methods of operation are discussed, including a method of summarizing terms and conditions of a customer agreement and a method of providing summarized terms and conditions of a customer agreement. Finally, a block diagram of an example computer system is described, with which or upon which various embodiments may be implemented. It should be appreciated that some embodiments may utilize more than one computer system and/or a distributed computer system.

### Operation

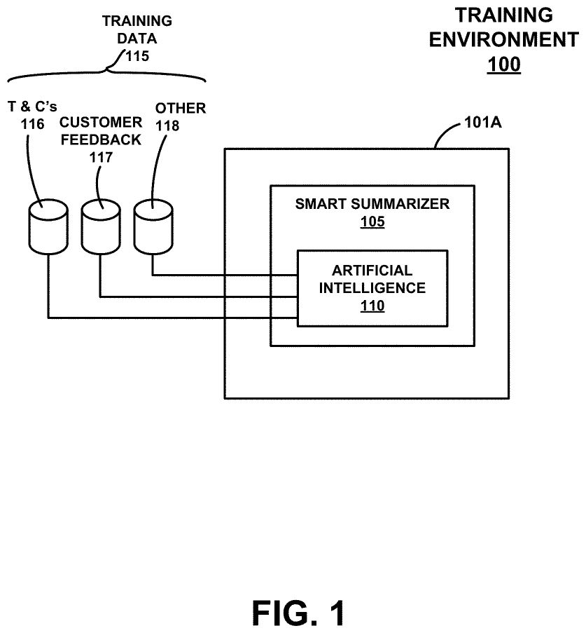

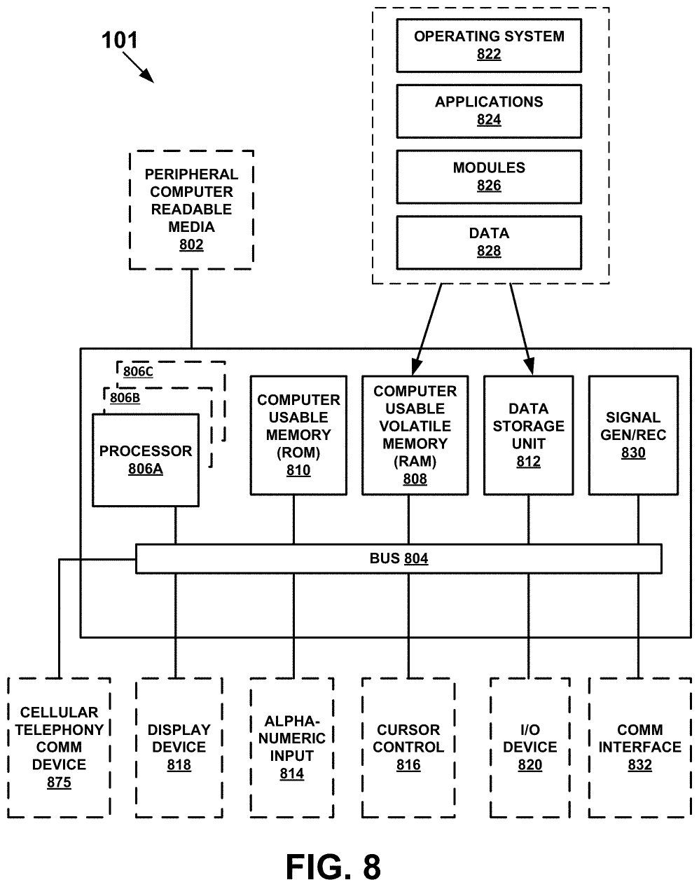

Referring now to the figures, FIG. 1 illustrates a block diagram of a computer system 101A which includes an artificial intelligence 110 based smart summarizer 105, in accordance with various embodiments. Components of computer system 101A are described in greater detail in conjunction with discussion of computer system 101 of FIG. 8. FIG. 1 illustrates computer system 101A in a training environment 100.

Smart summarizer 105 operates to receive, as input, a set of terms and conditions for a consumer agreement and then provide, as output, a summary of the set of terms and conditions. The summary is far shorter than the terms and conditions which it is based upon and is in plain English as opposed to legal language or contractual language. At the heart of smart summarizer 105 is an artificial intelligence 110. Smart summarizer 105 doesn't become “smart” or capable of summarizing until artificial intelligence 110 has been trained on training data 115. That is, training artificial intelligence 110 allows smart summarizer 105 to function, and this training develops both the nature of what is summarized from a set of terms and conditions and how it is summarized. Once artificial intelligence 110 has been trained to achieve a smart summarizer 105, smart summarizer 105 may exist as an application or module stored in non-transitory computer readable storage media of computer system 101A (or elsewhere) and run by a processor.

Artificial intelligence 110 is a machine learning algorithm such as a standard or proprietary neural network which is trained on training data 115 to receive a set of terms and conditions and then summarize aspects which will be important to the issuer of an account to convey to an account holding customer and terms which will be considered important to the account holding customer. To do this, the artificial intelligence 110 receives training data 115, trains on the training data 115, outputs summaries created from the training data 115, and is provided with feedback upon the summaries so that the training of artificial intelligence 110 can be adjusted. Once artificial intelligence 110 is suitably trained, a smart summarizer 105 is achieved which can be used to create summaries of terms and conditions which are not training data.

Training data 115 includes a plurality of sets of terms and conditions 116, customer feedback 117 on the plurality of sets of terms and conditions 116. In some embodiments training data 115 also includes other training data 118. The sets of terms and conditions in plurality of sets of terms and conditions 116 are for customer agreements for accounts and have been previously in use with customers. The customer feedback 117 is or includes actual feedback on terms and conditions of the plurality of sets of terms and conditions 116. The customer feedback 117 may include, but is not limited to, one or more of: click tracking data (to include navigation tracking or other tracking data) from online customer viewings of the plurality of sets of terms and conditions 116; call center logs regarding customer questions about the plurality of sets of terms and conditions 116; call center audio regarding customer questions about the plurality of sets of terms and conditions 116. Artificial intelligence 110 receives training data 115 and trains on the data to “become” smart summarizer 105 which summarizes aspects of the plurality of sets of terms and conditions 116 based on the customer feedback 117. An account issuer may provide guidelines as a portion of training data 115 to require certain aspects, such as an interest rate on a carried balance, to always be included in a summary of terms and conditions. Similarly, an account issuer or other entity may provide other parameters to guide the training of artificial intelligence 110, including, but not limited to, parameters specifying not to summarize a particular subject or subjects of a set of terms and conditions; to concentrate only on certain subjects within a set of terms and conditions when creating a summary; and/or to limit a summary to being less than a certain word count (e.g., 150 words or less).

The click tracking portion of customer feedback 117 may be information regarding scrolling, navigation, hovering, view times, and clicking performed by customers related to online accessible versions of terms and conditions 116 when these terms and conditions were in force/applied to accounts of the customers. This click tracking provides data about which aspects of these sets of terms and conditions 116 were searched and viewed by customers and for how long they viewed any particular aspect. The click tracking data provides insight into aspects of the terms and conditions of the plurality of sets of terms and conditions 116 which were confusing, concerning, or important enough to warrant the customer to look up and view the aspect(s) online.

The call center logs portion of customer feedback 117 may include information about customer questions (which may include complaints) regarding the sets of terms and conditions in the plurality of sets of terms and conditions 116, thus giving insight into aspects of the terms and conditions of the plurality of sets of terms and conditions 116 which were confusing, concerning, or important enough to warrant a customer call. The term “call center” may refer to any center which allows humans to interface with account holding customers (or potential customers), including, but not limited to: telephone call centers; and internet chat/call centers where at least a portion of the exchange with a customer is text based chatting (such as in a pop up window on the customer's device/computer).

The call center audio portion of customer feedback 117 may include conversations about customer questions (which may include complaints) regarding the sets of terms and conditions in the plurality of sets of terms and conditions 116, thus giving insight into aspects of the terms and conditions of the plurality of sets of terms and conditions 116 which were confusing, concerning, or important enough to warrant a customer call. The term “call center” may refer to any facility which allows a human, such as an account representative, to interface with account holding customers (or potential customers), including, but not limited to: telephone call centers; and internet chat/call centers where at least a portion of the exchange with a customer is an audible conversation. In some embodiments, this audio may be in the form of a text transcript. The transcript may be generated from the call center audio by a human and/or by a speech to text algorithm.

Other training data 118, when included, may comprise one or some combination of information from websites, news articles, and/or social media. The other training data 118 may include analysis, identification, and/or quantification of trends in consumer and/or customer sentiment regarding terms and conditions for legal and/or financial documents. For example, if a particular topic such as annual percentage rate (APR) on credit cards or loans is seeing a large increase in online announcements, online news, or online or discussion (e.g., on Yahoo Finance, in online articles in the Wall Street Journal, on social media, etc.) then data from such online sources can be captured and used as training data 118 which is input to and utilized to train artificial intelligence 110 on which aspect(s) of a set of terms and conditions should be summarized.

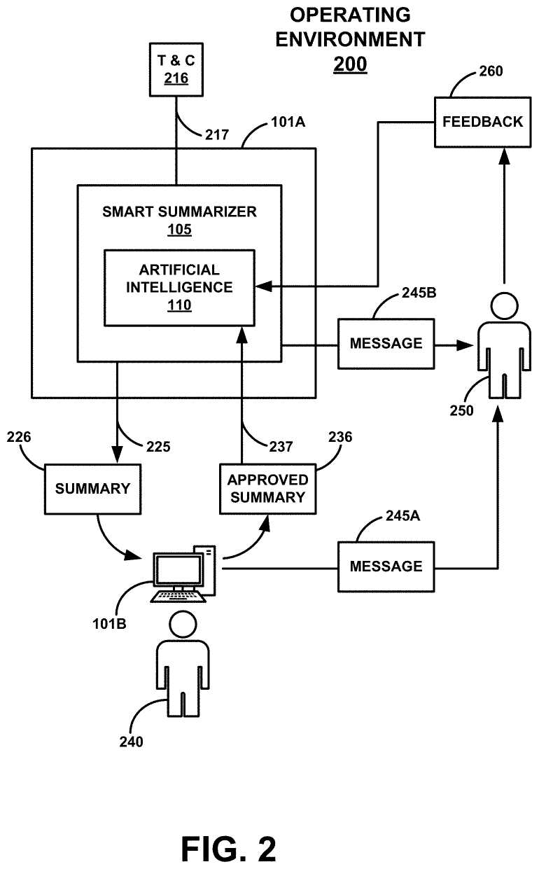

FIG. 2 illustrates a block diagram of the operation of the computer system 101A which includes an artificial intelligence 110 based smart summarizer 105, in accordance with various embodiments. FIG. 2 illustrates smart summarizer 105 in an operational environment 200 where, after it has been suitably trained, it may (but is not required to) be disconnected from receiving training data 115 as input.

In operational environment 200, smart summarizer 105 receives non-training data (i.e., a new set of terms and conditions 216) as input and operates to create a summary 226 from the received terms and conditions 216. Based on previous training of artificial intelligence 110, smart summarizer 105 creates a summary 226 and provides it as an output 225 in a human-readable format, such as an email message or text displayed on a display. For example, in some embodiments, human reviewer 240 may review summary 226 on the display of computer system 101 B. Human reviewer 240 may edit summary 226 to create an approved summary 236 or simply sign-off on summary 226 and then approve it so that it becomes approved summary 236. In other embodiments, a human reviewer 240 is not utilized or required, or may be utilized for a period of time to ensure smart summarizer 105 is functioning well and then either omitted or else used only at intervals for quality checks.

Approved summary 236 is received 237 back at artificial intelligence 110. Artificial intelligence 110 examines approved summary 236 for changes from summary 226. Artificial intelligence 110 uses any changes between summary 226 and approved summary 236 to retrain artificial intelligence 110. Artificial intelligence 110 uses any items which remained the same between summary 226 and approved summery 236 to reinforce existing training of artificial intelligence 110.

In some embodiments, human reviewer 240 and/or computer system 101B may format a message 245A, which includes approved summary 236, for an account holding customer 250 and then send the message out to customer 250. In other embodiments, smart summarizer 105 or some other portion of computer system 101A may format a message 245B, which includes either summary 226 or approved summary 236 (if one was received), for an account holding customer 250 and then send the message 245B out to customer 250.

A message 245 (e.g., 245A or 245B) may be generated in one or more of a plurality of formats. The formats of the message 245 may include, but are not limited to: an audio message which is sent/delivered via a telephone call to a phone number of customer 250; a cellular text message (i.e., a short message service (SMS) message and/or multimedia message service (MMS) message) which is delivered/sent by texting it to a cellular telephone number of customer 250; a letter which is printed and sent/delivered by mailing it via a postal service (or package delivery service) to the physical address of customer 250; an electronic mail (email) message which is sent/delivered over the Internet to an email account of the customer 250.

In some instances, customer 250 may provide feedback 260 on the message 245 and/or the terms and conditions 216 that have been summarized in message 245. Feedback 260 may be similar to customer feedback 117 in that it is received by any means by the issuer of the account, with some of the more typical means being: calls to a call center; email messages; and tracked clicks/navigation regarding an online accessible copy of terms and conditions (which may be accessed on a webpage or from a link in a cellular text message or email version of message 245). It should be appreciated that, even if training data 115 is decoupled from artificial intelligence 110, the training of artificial intelligence 110 may continue based upon feedback 260 from one or more customers 250 who have received a message 245 which included summary 226 or approved summary 236. In this manner, based on customer feedback 260, smart summarizer 105 may create a new, revised version, of summary 226. This revised summary may be output 225 again for review by human reviewer 240.

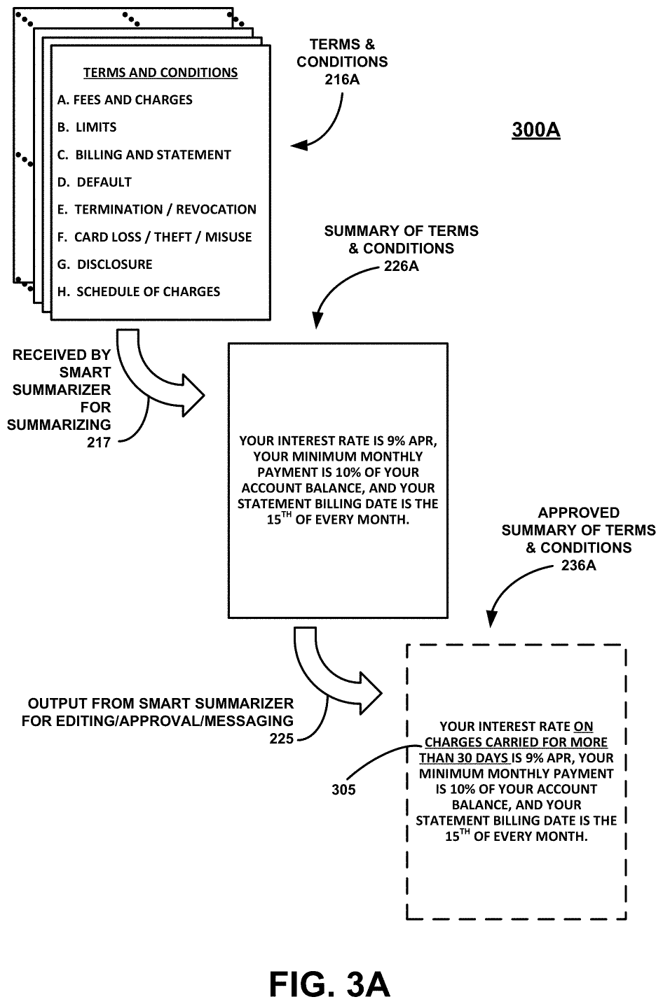

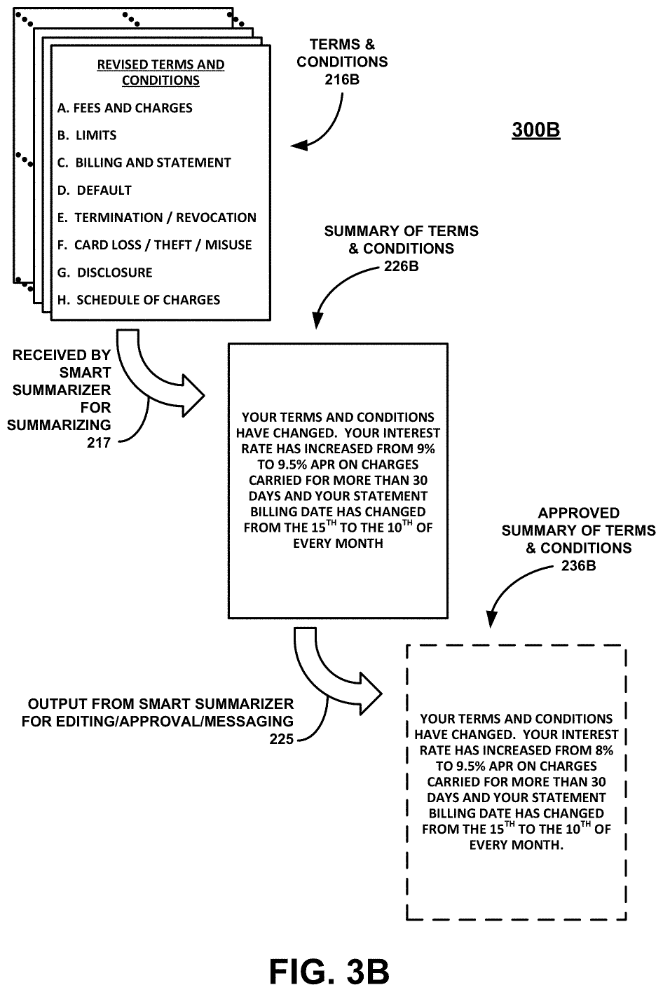

FIG. 3A is a diagram 300A illustrating the creation of a summary 226A and an approved summary 236A from a set of terms and conditions 216A, in accordance with an embodiment. With reference to FIGS. 2 and 3A, a set of terms and conditions 216A is received 217 by a smart summarizer 105. In this example, terms and conditions 216A are for a newly issued credit card or store charge card. The set of terms and conditions 216A is typically hundreds if not thousands of words long, with multiple sections and many pages. Typically the set of terms and conditions 216A is very legalistic which might cause a customer to remark, “tl;dr.” After receipt, smart summarizer 105 creates a short, plain English summary 226A of aspects which have been learned to be important through training of artificial intelligence 110 with training data 115. In this example, summary 226A includes information about: 1) the interest rate; 2) the minimum monthly payment; and 3) the statement billing date. In other instances, based on training, parameters, and/or legal requirements, a greater or lesser number of aspects and/or other aspects of a set of terms and conditions may be presented in a summary 226. In some embodiments, the summary 226A may be output 225 for review by a human reviewer 240. In such an embodiment, the human reviewer 240 may approve the summary 226A with or without changes, to achieve an approved summary 236A of terms and conditions 216A. In FIG. 3A, the human reviewer 240 has added content 305 to summary 226A to achieve approved summary 236A. The added content 305 (indicated by underlining) clarifies that the interest rate is on charges carried for more than 30 days. In some embodiments, the approved summary 236A is received 237 by smart summarizer 105 as feedback and used for additional training of artificial intelligence 110. Either of the summary 226A and the approved summary 236A may be utilized in a message 245 to a customer 250, posted on a webpage, or in another manner.

FIG. 3B is a diagram 300B illustrating the creation of a summary 226B and an approved summary 236B from a set of terms and conditions 216B, in accordance with an embodiment. With reference to FIGS. 2 and 3B, a set of terms and conditions 216B is received 217 by a smart summarizer 105. In this example, terms and conditions 216B are revised terms and conditions for a currently issued credit card or store charge card. That is, terms and conditions 216B revise or supplant a previous set of terms and conditions, such as terms and conditions 216A, of a customer agreement to which an account holding customer was subject. The set of terms and conditions 216B is typically hundreds if not thousands of words long, with multiple sections and many pages. Typically the set of terms and conditions 216B is very legalistic which might cause a customer to remark, “tl;dr.” The length of terms and conditions 216B may be particularly annoying or off-putting to a customer 250, as there may be only small changes from a previous set of terms and conditions 216A, and these small changes may be difficult for customer 250 to discern or ferret out; leading customer 250 to feel like the account holder may be trying to hide the changes or other information.

After receipt, smart summarizer 105 creates a short, plain English summary 226B of aspects which have been learned to be important through training of artificial intelligence 110 with training data 115. In this example, summary 226B includes information about: 1) the changed interest rate; and 2) the changed statement billing date. In other instances, based on training, parameters, or legal requirements, a greater or lesser number of aspects and/or other aspects of a set of revised terms and conditions may be presented in a summary. In some embodiments, the summary 226B may be output 225 for review by a human reviewer 240. In such an embodiment, the human reviewer 240 may approve the summary 226B with or without changes, to achieve an approved summary 236B of set of terms and conditions 216B. In FIG. 3B, there are no changes or differences between summary 226B and approved summary 236B. In some embodiments, the approved summary 236B is received 237 by smart summarizer 105 as feedback and used for additional training of artificial intelligence 110. Either of the summary 226B and the approved summary 236B may be utilized in a message 245 to a customer 250, posted on a webpage, or used in another manner.

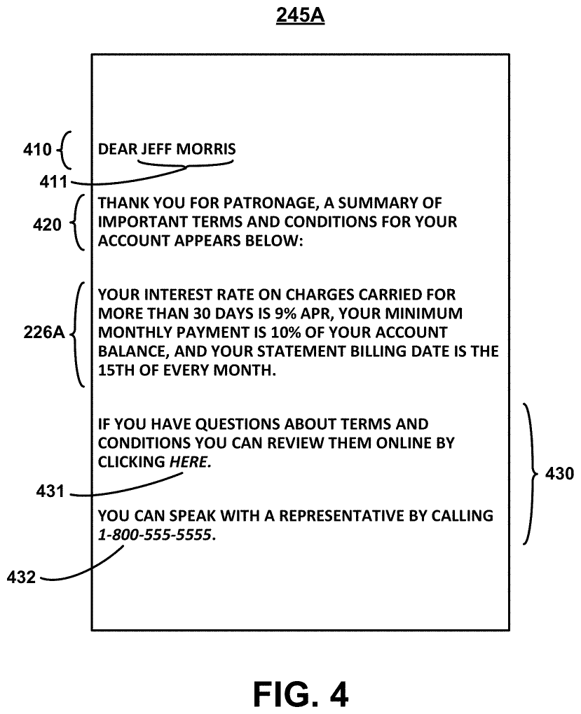

FIG. 4 depicts an example message 245 to be sent to one or more customers, in accordance with various embodiments. In this example, message 245 is formatted as an MMS text message to be texted to the cellular telephone associated with the customer for whom message 245 is prepared. In other instances, message 245 may be formatted as a telephone message script, a postal letter, an email, hypertext markup language, or in some other format. With Reference to FIG. 2, FIG. 3A, and FIG. 4, example message 245 includes a salutation 410 which may be customized with the name 411 of a particular customer 250 to whom message 245 will be sent. An introduction 420 describes the content of message 245. Summary 226 (e.g., summary 226A) is included in or as the body of message 245. In other embodiments, an approved summary 236 may be included instead of a summary 226. A conclusion 430 provides mechanisms for the customer 250 to acquire more information about the terms and conditions 216A which were described by summary 226A, and may include one or both of a selectable link 431 (such as the italicized word “HERE” in FIG. 4) which will open a webpage or document that displays the terms and conditions 216A and a telephone number 432 (e.g., the number 1-800-555-5555″ in FIG. 4) to contact an account representative or a call center which is trained to answer questions about the account of customer 250. In some embodiments, selecting the telephone number 432 with a user interface may cause a mobile device such as cellular telephone to dial the telephone number. It should be appreciated that message 245 is only an example, and that in other embodiments a message may include different information, more information, or less information. In some embodiments, some of the content of message 245, such as introduction 420 and/or conclusion 430 may be generated as part of a summary 226 or approved summary 236. In any embodiment, a message 245 will include at least a summary 226 or an approved summary 236 and may include additional information. In various embodiments, message 245 may be generated and/or sent by a computer such as computer system 101A (e.g., message 245B) or computer system 101B (e.g., message 245A) of FIG. 2.

### Additional Uses

Once a summary 226 or an approved summary 236 has been created it may be utilized in other manners besides being sent out in a message 245. For example, a summary 226 may be posted on a webpage next to a link to a set of terms and conditions 216 that it summarizes. Similarly, a summary may be completed based on a customer's real-time electronic request. For example, a selectable button titled “Summarize” or “TL;DR” or the like may be placed next to a set of terms and conditions 216 displayed on a webpage or even embedded in a set of terms and conditions 216 that are displayed on a webpage. In response to a customer 250 or other user selecting the button, a summary 226 of the terms and conditions 216 is provided to the customer 250 or another user. The summary 226 may have been created previously by smart summarizer 105 or may be created in real-time upon request by smart summarizer 105. In some embodiments, an input window may be provided in conjunction with the selectable button to allow the customer 250 or user to input a parameter for the summary which is provided/generated. For example, a customer 250 or another user may enter “APR” into the window and then select the button. The summary 226 that is created and returned to the customer 250 is then tailored to include only aspects related to the annual percentage rate of interest as discussed in the set of terms and conditions 216.

In some embodiments, smart summarizer 105 may be utilized to create a summary 226 of the terms and conditions of one or more competitor products. For example, such a summary 226 or summaries would allow a company or person to easily evaluate competitor products for aspects known to be of importance to the company's current customers 250. Put differently, once artificial intelligence 110 has been trained to create a summary of a company's own terms and conditions in a manner that summarizes information relevant to the company's customers 250, terms and conditions for competitor products can be provided as an input to the same smart summarizer 105 and its trained artificial intelligence 110. The summary 226 which is output 225 could then be used to easily monitor the state of terms and conditions of a competitor. For example, if a desired strategy of a company was to have the lowest annual percentage rate (APR) in the industry for a credit card or store charge card, then knowing the APRs across all competing products could be leveraged to execute that strategy. If smart summarizer 105 pulls out and summarizes APR information from a set of terms and conditions 216 of a company, then it can be similarly used to pull out and summarize this APR information for competitor's terms and conditions. Likewise, any information that is summarized by smart summarizer 105 from a company's own terms and conditions 216 can similarly and easily be extracted and summarized from competitor's terms and conditions by smart summarizer 105.

In some embodiments, smart summarizer 105 may be utilized to create a summary 226 of the terms and conditions 216 for internal use at a company. For example, a summary 226 may be created for auditing purposes, such as to quickly confirm that important aspects of a set of terms and conditions 216 listed online or available electronically match the same aspects of a printed version of the terms and conditions 216 that may be mailed or otherwise provided in printed form to a customer 250. A mismatch in these terms can easily occur, for example, when an electronically maintained version of the terms and conditions is updated but the update is not synchronized with printed terms which may have been mailed out or provided in advance for a print advertising campaign. Conventionally, auditing for differences between printed and electronic versions of a set of terms and conditions 216 is accomplished by extensive manual review which can be both time consuming and prone to errors. Errors in a set of terms and conditions 216 in the form of incorrect fees, interest rates, and the like can be costly in the form of fee waivers and time and money spent on remediation provided to customers who relied upon the erroneous terms. Because of this risk, it would be advantageous to use an automated summary 226 of one or more of the electronic and printed sets of terms and conditions 216 to either replace the above-described manual review or to supplement and double check the manual review. In either case, improved accuracy and reduced errors facilitated by using summaries 226 will result in one or both of a decrease in resources dedicated to auditing and a decrease in fee waivers and time/money remediating a set of terms and conditions distributed to customers 250 with errors.

### Example User Requested Summary

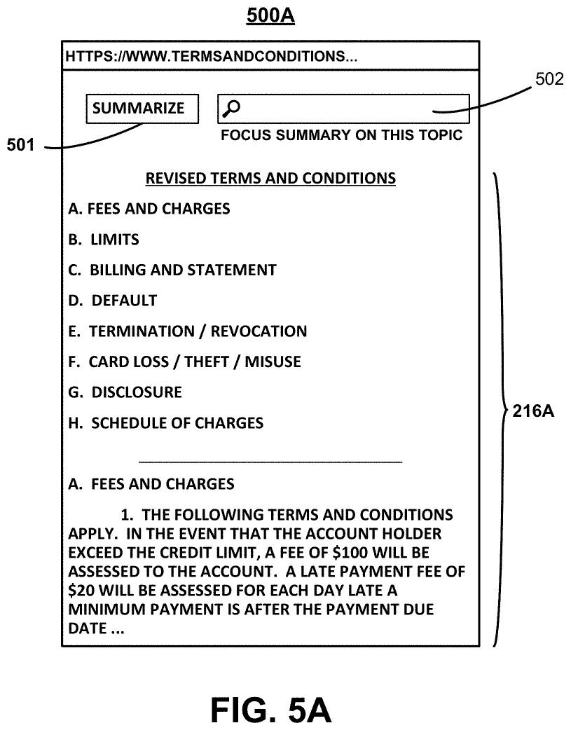

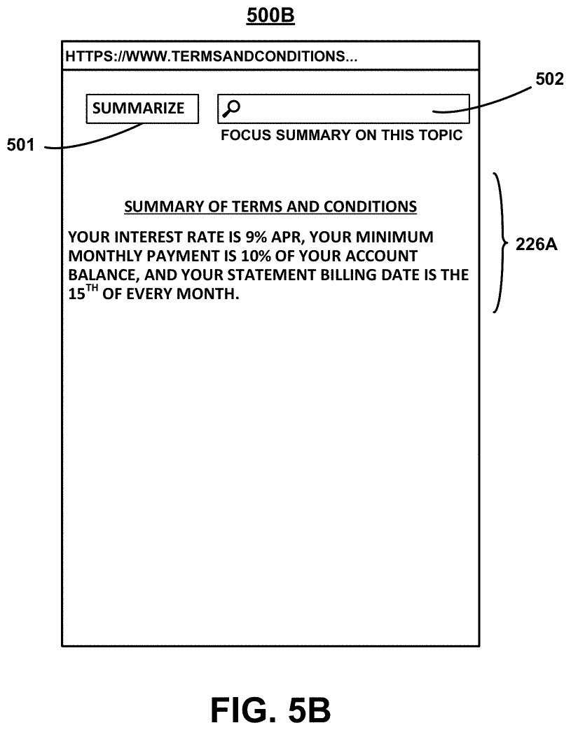

FIG. 5A illustrates a webpage 500A which permits a user of the webpage to request a summary of a set of terms and conditions, in accordance with various embodiments. In one embodiment, webpage 500A may present a set of terms and conditions, such as terms and conditions 216A. Additionally, webpage 500A may present a selectable radio button, such as “summarize” button 501. When selected and engaged by a user (i.e., a customer 250) of webpage 500A, summarize button 501 sends a request for a summary of terms and conditions 216A to smart summarizer 105. This may cause smart summarizer to either: 1) receive 217 terms and conditions 216A for summary; or 2) receive a request to provide a previously created summary of terms and conditions 216A. In response, smart summarizer 105 returns a summary 226, approved summary 236, or message 245 which can be displayed. In some embodiments, webpage 500A may also include a search field window 502 which allows a user to submit a term, such as “APR” or “minimum payment” such that the returned summary is focused on summarizing aspects related to the entered search term.

FIG. 5B illustrates a webpage 500B which is displaying a summary returned in response to a request for a summary of a set of terms and conditions, in accordance with various embodiments. For example, in response to a user of webpage 500A selecting summarize button 501, webpage 500A is updated to webpage 500B which displays summary 226A of terms and conditions 216A.

### Example Methods of Operation

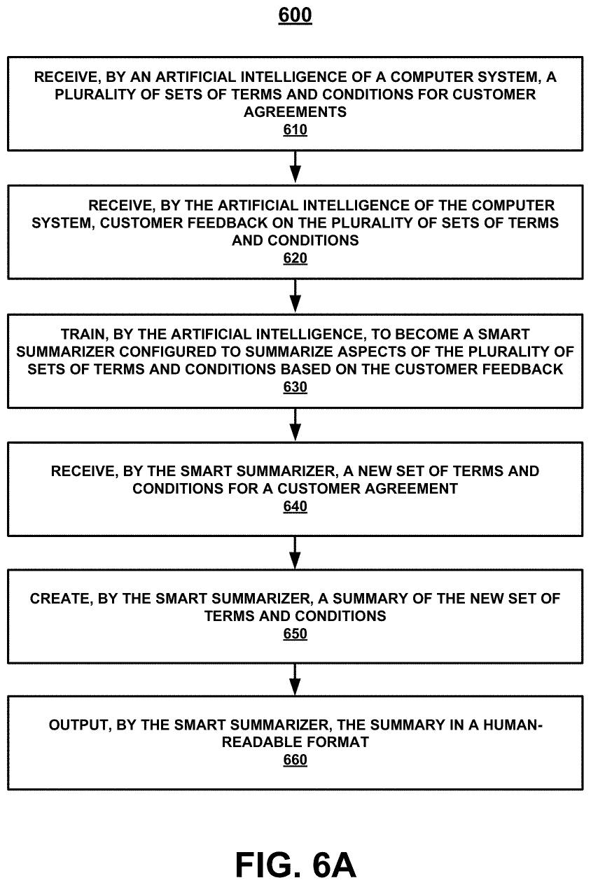

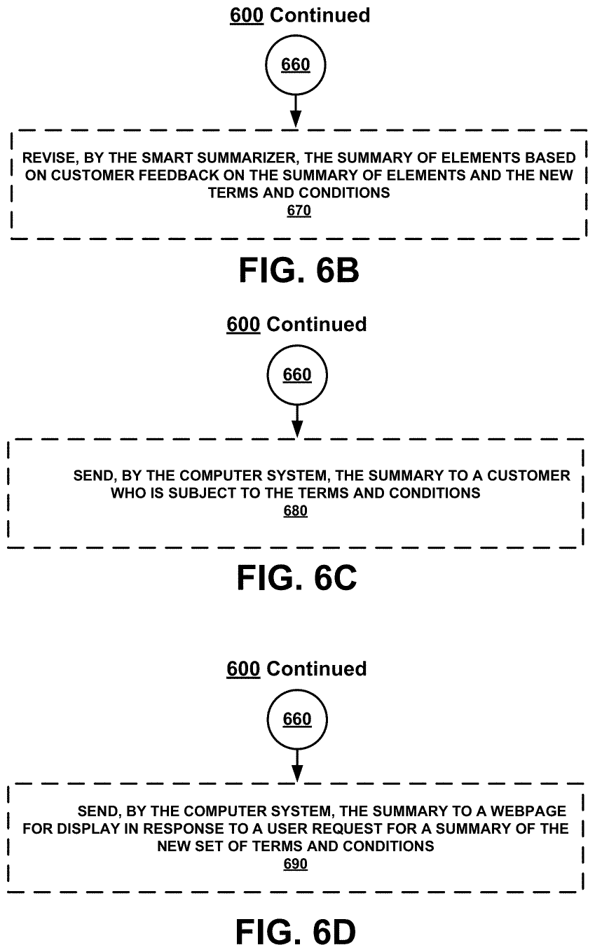

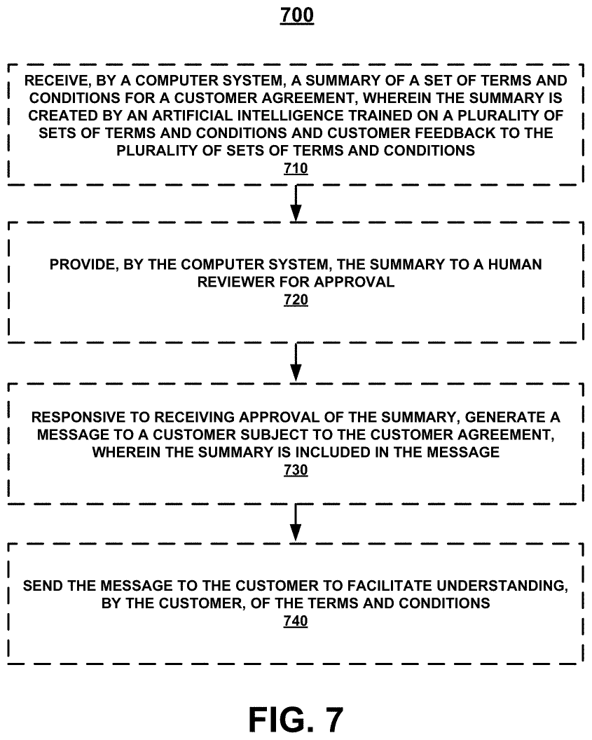

The following discussion sets forth in detail the operation of some example methods of operation. With reference to FIGS. 6A-6D and FIG. 7, flow diagrams 600 and 700 illustrate example procedures used by various embodiments. Flow diagrams 600 and 700 include some procedures that, in various embodiments, are carried out by one or more processors under the control of computer-readable and computer-executable instructions. In this fashion, procedures described herein and in conjunction with flow diagrams 600 and 700 are, or may be, implemented in an automated fashion using a computer, such as computer system 101 of FIG. 8, in various embodiments. The computer-readable and computer-executable instructions can reside in any tangible, non-transitory computer-readable storage media, such as, for example, in data storage features such as peripheral computer-readable storage media 802, RAM 808, ROM 810, and/or data storage unit 812 (all illustrated in FIG. 8) or the like. The computer-readable and computer-executable instructions, which reside on tangible, non-transitory computer-readable storage media, are used to control or operate in conjunction with, for example, one or some combination of processor(s) 806 (see FIG. 8), or other similar processor(s) of a computer system such as, but not limited to computer system 101 of FIG. 8. Although specific procedures are disclosed in flow diagram 600 and in flow diagram 700, such procedures are examples. That is, embodiments are well suited to performing various other procedures or variations of the procedures recited in flow diagram 600 and/or flow diagram 700. Likewise, in some embodiments, the procedures in flow diagram 600 and/or flow diagram 700 may be performed in an order different than presented and/or not all of the procedures described may be performed. It is further appreciated that some or all of the procedures described in flow diagrams 600 and 700 may be implemented in hardware, or a combination of hardware with firmware and/or software.

### Example Method of Summarizing Terms and Conditions of a Customer Agreement

FIGS. 6A-6D depict a flow diagram 600 of a method of summarizing terms and conditions of a customer agreement, in accordance with various embodiments. Reference will be made to aspects of FIGS. 1-4, 5A, and 5B in the description of flow diagram 600.

Referring now to FIG. 6A, at procedure 610 of flow diagram 600, in various embodiments, an artificial intelligence of a computer system receives a plurality of sets of terms and conditions for customer agreements. With reference to FIG. 1, this may comprise computer system 101A and artificial intelligence 110 receiving training data 115 in the form of a plurality of sets of terms and conditions 116. The sets of terms and conditions of plurality of sets of terms and conditions 116 being for customer accounts, such as credit card accounts, store charge accounts, brand loyalty/reward accounts, or the like. In some embodiments, all of the sets of terms and conditions of plurality of sets of terms and conditions 116 may be for a particular type of account, such as credit card accounts. In some embodiments, additional training data 115 (beyond sets of terms and conditions 116) may be utilized for training artificial intelligence 110.

At procedure 620 of flow diagram 600, in various embodiments, an artificial intelligence of a computer system, receives customer feedback on the plurality of sets of terms and conditions. With reference to FIG. 1, this may comprise computer system 101A and artificial intelligence 110 receiving training data 115 in the form customer feedback 117 that has been maintained for the plurality of sets of terms and conditions 116 and/or for other terms and conditions besides the plurality of sets of terms and conditions 116. The customer feedback 117 can be in many formats (which may be normalized to text or another common format in some embodiments) and from a variety of sources. Without limitation, in various embodiments, the customer feedback 117 may comprise click tracking data, navigation tracking data, and/or other website tracking data from online customer viewings of the plurality of sets of terms and conditions 116 or online viewings of other terms and conditions; call center logs regarding customer questions about the plurality of sets of terms and conditions 116 and/or other terms and conditions; and call center audio regarding customer questions about the plurality of sets of terms and conditions 116 and/or other terms and conditions.

At procedure 630 of flow diagram 600, in various embodiments, the artificial intelligence trains to become a smart summarizer configured to summarize aspects of the plurality of sets of terms and conditions based on the customer feedback. This training may involve standardized or customized training of artificial intelligence 110 using the plurality of sets of terms and conditions 116 and customer feedback 117 as training data 115 to practice summarizing sets of terms and conditions in the plurality of sets of terms and conditions 116 in a manner which will satisfy a variety of concerns expressed in customer feedback 117. Once artificial intelligence 110 has been trained, a smart summarizer 105 is achieved (i.e., becomes operational and functional) which can accept a new (non-training) set of terms and conditions 216 as an input and then summarize it.

At procedure 640 of flow diagram 600, in various embodiments, the smart summarizer receives a new set of terms and conditions for a customer agreement. This may comprise a smart summarizer receiving a new (non-training) set of terms and conditions 216 as an input and then creating a summary from it. The new set of terms and conditions 216 is for a customer agreement for an account such as a credit card account, store credit account, brand loyalty/reward program account, or the like. In some embodiments, the terms and conditions 216 may be of the same form of consumer agreement as the plurality of sets of terms and conditions 116 used for training artificial intelligence 110. For example, in an embodiment where all of the sets of terms and conditions of the plurality of sets of terms and conditions 116 are associated with credit card account agreements, then artificial intelligence 110 may be specifically trained to summarize terms and conditions for credit card account agreements. In such an embodiment, terms and conditions 216 may thus be a set of terms and conditions for a credit card account agreement with a customer 250. In some embodiments, where a current set of terms and conditions govern a customer agreement, terms and conditions 216 may be a revision to or a replacement for the existing terms and conditions.

At procedure 650 of flow diagram 600, in various embodiments, the smart summarizer creates a summary of the new set of terms and conditions. With reference to FIG. 2, this can comprise smart summarizer 105 creating summary 226 from terms and conditions 216. With reference to FIG. 3B, in an embodiment where new terms and conditions 216B comprise revised or replacement terms and conditions, smart summarizer 105 may compare the new terms and conditions 216B to the existing terms and conditions 216A being revised or replaced and create a summary 226B of the new terms and conditions 216B which summarizes revisions enacted between the new set of terms and conditions 216B and a previous set of terms and conditions 216A which was revised to create the new set of terms and conditions 216B or which is being replaced by the new set of terms and conditions 216B.

At procedure 660 of flow diagram 600, in various embodiments, the smart summarizer outputs the summary in a human-readable format. With reference to FIGS. 2, 3A, and 3B, this can comprise smart summarizer outputting 225 a summary 226 that is in a form which may be readable, printable (and then readable), or displayable (and then readable) by a human, such as human reviewer 240. For example, the summary 226 may be displayed on a display of computer system 101B or printed by a printer attached to computer system 101B such that they may be read by human reviewer 240.

Referring now to FIG. 6B, at procedure 670 of flow diagram 600, in various embodiments, the smart summarizer 105 revises the summary based on customer feedback on the summary and the new terms and conditions. For example, if summary 226 or a message which includes summary 226 is sent to a customer 250, the customer may provide feedback 260 on either or both of summary 226 and the terms and conditions 216 which were summarized. The feedback 260 may be in the form of emails, text messages, chat window messages, call center logs, call center audio, click/navigation tracking on a web available set of terms and conditions 216, or some other form. This feedback 260 may be provided to artificial intelligence 110 to further train artificial intelligence 110 in the manner previously performed using training data 115.

Referring now to FIG. 6C, at procedure 680 of flow diagram 600, in various embodiments the summary is sent to a customer who is subject to the terms and conditions. This may comprise computer system 101A or another computer system (e.g., computer system 101B) generating a message 245 to send to the customer. The message 245 may be a cellular text message, an electronic mail message, a printed letter to be mailed via a postal service or other package delivery service, or the like. The message may then be sent by, or the sending may be coordinated and/or effected by, the computer system 101. This may comprise the computer system 101 sending out the message 245 as a cellular text message, as an electronic mail message, or interacting with a mail generation system to send out message 245 as a letter to be delivered by a postal service or the like. Computer system 101 may post summary 226 or approved summary 236 or message 245 to a webpage. Computer system 101 may also send the summary 226, approved summary 236, or message 245 out to the webpage or other location in response to receiving a request for a summary of terms and conditions 216.

Referring now to FIG. 6D, at procedure 690 of flow diagram 600, in various embodiments the summary to a webpage for display in response to a user request for a summary of the new set of terms and conditions. With reference to FIGS. 5A and 5B, this can comprise smart summarizer 105 sending a summary 226, approved summary 236, or message 245 to a webpage such as webpage 500B in response to a user request for a summary of a set of terms and conditions. For example, in one embodiment, in response to a user selecting summarize button 501 on webpage 500A, smart summarizer 105 generates a summary of set of terms and conditions 216, outputs a summary 226, and sends that summary to webpage 500B where it is displayed. In some embodiments, the returned summary may be focused on a term provided by the user, such as in search field window 502, in conjunction with the request for a summarization of a set of terms and conditions.

### Example Method of Providing Summarized Terms and Conditions of a Customer Agreement

FIG. 7 depicts a flow diagram 700 of a method of providing summarized terms and conditions of a customer agreement, in accordance with various embodiments. Reference will be made to aspects of FIGS. 1-4, 5A, 5B, and FIGS. 6A-6D in the description of flow diagram 600.

Referring now to FIG. 7, at procedure 710 of flow diagram 700, in one embodiment, a computer system receives a summary of a set of terms and conditions for a customer agreement. The summary is created by an artificial intelligence (e.g., artificial intelligence 110) trained on a plurality of sets of terms and conditions (e.g., plurality of sets of terms and conditions 116) and customer feedback (e.g., customer feedback 117) to the plurality of sets of terms and conditions (e.g., plurality of sets of terms and conditions 116). With reference to FIGS. 1 and 2, this can comprise a computer system, such as computer system 101 B, receiving a summary 226 that is output 225 from smart summarizer 105.

At procedure 720 of flow diagram 700, in one embodiment, the summary is provided to a human reviewer for approval. This may comprise computer system 101B sending the summary 226 to a human reviewer 240 via an electronic mail message, displaying the summary 226 on a display of computer system 101B, or making the summary 226 available in a program or application which facilitates viewing, reviewing, and/or editing by human reviewer 240.

At procedure 730 of flow diagram 700, in one embodiment, responsive to receiving approval of the summary, a message to a customer subject to the customer agreement is generated, and the summary is included in the message. With reference to FIG. 2, this can comprise computer system 101B generating message 245A based upon approved summary 236 being created/achieved after review of summary 226 by human reviewer 240. With continued reference to FIG. 2, this can alternatively comprise computer system 101A generating message 245B based upon approved summary 236 being created/achieved and the received 237 after review of summary 226 by human reviewer 240. The message 245 may be generated in anyone of a variety of forms including, but not limited to: a cellular text message; an electronic mail message; and a letter to be mailed via a postal service. It should be appreciated that the message 245 may be generated in multiple forms to “shotgun” deliver it through multiple different channels of communication to customer 250.

At procedure 740 of flow diagram 700, in one embodiment, the message is sent to the customer to facilitate understanding, by the customer, of the terms and conditions. This can comprise a computer system 101 (e.g., 101A, 101B, or another computer system) sending the message 245 via a means suitable to the form of the message 245. For example, this may comprise the computer system 101 sending a message 245 via a cellular network to a cellular telephone number associated with customer 250 when message 245 has been generated as a cellular text message. This may also comprise the computer system 101 sending a message 245 via an email server over the Internet to be delivered to an email address associated with customer 250 when message 245 has been generated as an electronic mail message. This may also comprise the computer system 101 coordinating and effecting the sending of message 245 via a postal service (or other package delivery service), in a format such as a letter addressed to an address of customer 250 when message 245 has been generated as a mailable letter. It should be appreciated that the message 245 may be sent through multiple different channels of communication to customer 250 in order to ensure that the customer 250 receives the message 245. These transmissions may be simultaneous or may be staggered in a manner that uses less expensive modes first. For example, a hierarchy may be: first via email, second via cellular text message, third via robotic phone call, and fourth via postal letter. In some embodiments, when receipt is confirmed by one the modes earlier in the hierarchy the other modes of delivery later in the hierarchy are suspended or cancelled in order to conserve money and reduce the information flow pushed to customer 250.

### Example Computer System

With reference now to FIG. 8, all or portions of some embodiments described herein are composed of computer-readable and computer-executable instructions that reside, for example, in computer-usable/computer-readable storage media of a computer system. That is, FIG. 8 illustrates one example of a type of computer (computer system 101) that can be used in accordance with or to implement various embodiments which are discussed herein. It is appreciated that computer system 101 of FIG. 8 is only an example and that embodiments as described herein can operate on or within a number of different computer systems including, but not limited to, general purpose networked computer systems, embedded computer systems, server devices, client devices, various intermediate devices/nodes, standalone computer systems, media centers, handheld computer systems, multi-media devices, and the like. FIG. 8 represents a system or components that may be used in conjunction with aspects of the present technology. In one embodiment, some or all of the components described herein may be combined with some or all of the components of FIG. 8 to practice the present technology.

As shown in FIG. 8, computer system 101 is well adapted to optionally have peripheral computer readable storage media 802 such as, for example, a disk, a compact disc, a flash drive, and the like coupled thereto.

Computer system 101 of FIG. 8 includes an address/data/control bus 804 for communicating information, and a processor 806A coupled to bus 804 for processing information and instructions. As depicted in FIG. 8, computer system 101 is also well suited to a multi-processor environment in which a plurality of processors 806A, 806B, and 806C are present. Conversely, computer system 101 is also well suited to having a single processor such as, for example, processor 806A, and optionally one or more additional processors (e.g., 806B, 806C, and the like). Processors 806A, 806B, and 806C may be any of various types of microprocessors. Computer system 101 also includes data storage features such as a computer usable volatile memory 808, e.g., random access memory (RAM), coupled to bus 804 for storing information and instructions for processors 806A, 806B, and 806C. Computer system 101 also includes computer usable non-volatile memory 810, e.g., read only memory (ROM), coupled to bus 804 for storing static information and instructions for processors 806A, 806B, and 806C. Also present in system 101 is a data storage unit 812 (e.g., a magnetic disk drive, optical disk drive, solid state drive (SSD), and the like) coupled to bus 804 for storing information and instructions. Signal generating and receiving device(s) 830 of the present embodiment may include wired serial adaptors, modems, and network adaptors, wireless modems, and wireless network adaptors, and other such communication technology.

Computer system 101 also optionally includes an alpha-numeric input device 814 including alphanumeric and function keys coupled to bus 804 for communicating information and command selections to processor 806A or processors 806A, 806B, and 806C. Computer system 101 also optionally includes a cursor control device 816 coupled to bus 804 for communicating user input information and command selections to processor 806A or processors 806A, 806B, and 806C. Optional cursor control device may be a touch sensor, gesture recognition device, and the like. Computer system 101 of the present embodiment also optionally includes a display device 818 coupled to bus 804 for displaying information.

Referring still to FIG. 8, optional display device 818 of FIG. 8 may be a liquid crystal device, cathode ray tube, OLED, plasma display device or other display device suitable for creating graphic images and alpha-numeric characters recognizable to a user. Optional cursor control device 816 allows the computer user to dynamically signal the movement of a visible symbol (cursor) on a display screen of display device 818. Many implementations of cursor control device 816 are known in the art including a trackball, mouse, touch pad, joystick, non-contact input, gesture recognition, voice commands, bio recognition, and the like. In addition, special keys on alpha-numeric input device 814 capable of signaling movement of a given direction or manner of displacement. Alternatively, it will be appreciated that a cursor can be directed and/or activated via input from alpha-numeric input device 814 using special keys and key sequence commands. System 101 also includes one or more signal generating and receiving device(s) 830 coupled with bus 804 for enabling system 101 to interface with other electronic devices and computer systems.

System 101 is also well suited to having a cursor directed by other means such as, for example, voice commands. Computer system 101 also optionally includes an I/O device 820 for coupling system 101 with external entities. For example, in one embodiment, I/O device 820 is a modem for enabling wired or wireless communications between system 101 and an external network such as, but not limited to, the Internet or intranet. A more detailed discussion of the present technology is found below.

Referring still to FIG. 8, various other components are depicted for system 101. Specifically, when present, an operating system 822, applications 824, modules 826, and data 828 are shown as typically residing in one or some combination of computer usable volatile memory 808, e.g., random access memory (RAM), and data storage unit 812. However, it is appreciated that in some embodiments, operating system 822 may be stored in other locations such as on a network or on a flash drive; and that further, operating system 822 may be accessed from a remote location via, for example, a coupling to the internet. In one embodiment, the present technology, for example, is stored as an application 824 or module 826 in memory locations within RAM 808 and memory areas within data storage unit 812. The present technology may be applied to one or more elements of described system 101.

The signal generating and receiving device(s) 830 may work in conjunction with one or more optionally included communication interface(s) 832 for coupling information to and/or from system 101. Communication interface 832 may include a serial port, parallel port, Universal Serial Bus (USB), Ethernet port, Bluetooth, thunderbolt, near field communications port, WiFi, Cellular modem, or other input/output interface. Communication interface 832 may physically, electrically, optically, or wirelessly (e.g., via radio frequency) couple computer system 101 with another device, such as a mobile phone, radio, or computer system.

Cellular telephony communication device 875, when included, interacts wirelessly with a cellular telephone network to send and receive messages via one or more cellular messaging services such as SMS (short message service) and/or MMS (multimedia message service).

The computing system 101 is only one example of a suitable computing environment and is not intended to suggest any limitation as to the scope of use or functionality of the present technology. Additionally, the computing environment should not be interpreted as having any dependency or requirement relating to any one or combination of components illustrated in the example computing system 101.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method of summarizing terms and conditions of a customer agreement, the method comprising:
receiving, by an artificial intelligence of a computer system, a plurality of sets of terms and conditions for customer agreements;
receiving, by the artificial intelligence of the computer system, customer feedback on the plurality of sets of terms and conditions;
training, by the artificial intelligence, to become a smart summarizer configured to summarize aspects of the plurality of sets of terms and conditions based on the customer feedback;
receiving, by the smart summarizer, a new set of terms and conditions for a customer agreement;
creating, by the smart summarizer, a summary of the new set of terms and conditions; and
outputting, by the smart summarizer, the summary in a human-readable format.

2. The method as recited in claim 1, further comprising:
revising, by the smart summarizer, the summary based on customer feedback on the summary and the new set of terms and conditions.

3. The method as recited in claim 1, further comprising:
sending, by the computer system, the summary to a customer who is subject to the new set of terms and conditions.

4. The method as recited in claim 1, further comprising:
sending, by the computer system, the summary to a webpage for display in response to a user request for a summary of the new set of terms and conditions.

5. The method as recited in claim 1, wherein the receiving, by the artificial intelligence of the computer system, customer feedback on the plurality of sets of terms and conditions comprises:
receiving click tracking data from online customer viewings of the plurality of sets of terms and conditions.

6. The method as recited in claim 1, wherein the receiving, by the artificial intelligence of the computer system, customer feedback on the plurality of sets of terms and conditions comprises:
receiving call center logs regarding customer questions about the plurality of sets of terms and conditions.

7. The method as recited in claim 1, wherein the receiving, by the artificial intelligence of the computer system, customer feedback on the plurality of sets of terms and conditions comprises:
receiving call center audio regarding customer questions about the plurality of sets of terms and conditions.

8. The method as recited in claim 1, wherein the receiving, by the smart summarizer, a new set of terms and conditions for a customer agreement, comprises:
receiving the new set of terms and conditions for a credit card agreement.

9. The method as recited in claim 1, wherein the receiving, by the smart summarizer, a new set of terms and conditions for a customer agreement, comprises:
receiving the new set of terms and conditions for a brand loyalty program.

10. The method as recited in claim 1, wherein the new set of terms and conditions comprise revised terms and conditions, and the creating, by the smart summarizer, a summary of the new set of terms and conditions comprises:
creating a revision summary which summarizes revisions enacted between the new set of terms and conditions and a previous set of terms and conditions which was revised to create the new set of terms and conditions.

11. A non-transitory computer readable storage medium having computer readable program instructions stored thereon which, when executed, cause a computer system to perform a method of summarizing terms and conditions of a customer agreement, the method comprising:
receiving, by an artificial intelligence of a computer system, a plurality of sets of terms and conditions for customer agreements;
receiving, by the artificial intelligence of the computer system, customer feedback on the plurality of sets of terms and conditions;
training, by the artificial intelligence, to become a smart summarizer configured to summarize aspects of the plurality of sets of terms and conditions based on the customer feedback;
receiving, by the smart summarizer, a new set of terms and conditions for a customer agreement;
creating, by the smart summarizer, a summary of the new set of terms and conditions; and
outputting, by the smart summarizer, the summary in a human-readable format.

12. The non-transitory computer readable storage medium of claim 11, wherein the method further comprises:
revising, by the smart summarizer, the summary based on customer feedback on the summary and the new set of terms and conditions.

13. The non-transitory computer readable storage medium of claim 11, wherein the receiving, by the artificial intelligence of the computer system, customer feedback on the plurality of sets of terms and conditions comprises:
receiving click tracking data from online customer viewings of the plurality of sets of terms and conditions.

14. The non-transitory computer readable storage medium of claim 11, wherein the receiving, by the artificial intelligence of the computer system, customer feedback on the plurality of sets of terms and conditions comprises:
receiving call center logs regarding customer questions about the plurality of sets of terms and conditions.

15. The non-transitory computer readable storage medium of claim 11, wherein the receiving, by the artificial intelligence of the computer system, customer feedback on the plurality of sets of terms and conditions comprises:
receiving call center audio regarding customer questions about the plurality of sets of terms and conditions.

16. The non-transitory computer readable storage medium of claim 11, wherein the receiving, by the smart summarizer, a new set of terms and conditions for a customer agreement, comprises:
receiving the new set of terms and conditions for a credit card agreement.

17. The non-transitory computer readable storage medium of claim 11, wherein the receiving, by the smart summarizer, a new set of terms and conditions for a customer agreement, comprises:
receiving the new set of terms and conditions for a brand loyalty program.

18. The non-transitory computer readable storage medium of claim 11, wherein the new set of terms and conditions comprise revised terms and conditions, and the creating, by the smart summarizer, a summary of the new set of terms and conditions comprises:
creating a revision summary which summarizes revisions enacted between the new set of terms and conditions and a previous set of terms and conditions which was revised to create the new set of terms and conditions.

19. A method of providing summarized terms and conditions of a customer agreement, the method comprising:
receiving, by a computer system, a summary of a set of terms and conditions for a customer agreement, wherein the summary is created by an artificial intelligence trained on a plurality of sets of terms and conditions and customer feedback to the plurality of sets of terms and conditions;
providing, by the computer system, the summary to a human reviewer for approval;
responsive to receiving approval of the summary, generating, by the computer system, a message to a customer subject to the customer agreement, wherein the summary is included in the message; and
sending, by the computer system, the message to the customer to facilitate understanding, by the customer, of the set of terms and conditions.

20. The method as recited in claim 19, wherein the generating, by the computer system, a message to a customer subject to the customer agreement comprises:
generating the message as a cellular text message.

21. The method as recited in claim 19, wherein the generating, by the computer system, a message to a customer subject to the customer agreement comprises:
generating the message as an electronic mail message.

22. The method as recited in claim 19, wherein the generating, by the computer system, a message to a customer subject to the customer agreement comprises:
generating the message as a letter to be mailed via a postal service.
